(19) United States
(12) Patent Application Publication
(10) Pub. No.: US 2026/0210413 A1
(43) Pub. Date: Jul. 23, 2026

(54) COMPACT ROTARY CLUTCH CONFIGURATION UTILIZING STACKED LAMINATIONS

(71) Applicant: ESTAT Actuation, Inc., Pittsburgh, PA (US)

(72) Inventors: Kirby A. Witte, Pittsburgh, PA (US); Stuart B. Diller, Pittsburgh, PA (US)

(73) Assignee: ESTAT Actuation, Inc., Pittsburgh, PA (US)

(21) Appl. No.: 19/143,845

(22) PCT Filed: Dec. 27, 2023
(86) PCT No.: PCT/US2023/086116

§ 371 Date: Jun. 26, 2025

Related U.S. Application Data
(60) Provisional application No. 63/435,387, filed on Dec. 27, 2022.

(51) Int. Cl. F16D 28/00; H02N 13/00

(52) U.S. Cl. CPC F16D 28/00; H02N 13/00

(57) ABSTRACT

A compact rotary clutch may include a plurality of clutch units in a stacked configuration. Each clutch unit comprises an electrode and a reinforcing structure capable of transmitting a load. Electrical connections may be established between the clutch units in the clutch to permit control of the clutch, which can operate in an engaged and disengaged states. Control of the clutch units may also permit slipping or attenuated relative rotation of input and output elements connected to the clutch.

### CROSS-REFERENCE TO RELATED APPLICATION

This application claims the benefit under 35 U.S.C. § 119 of U.S. Provisional Application Ser. No. 63/435,387, filed on Dec. 27, 2022, which is incorporated herein by reference.

### STATEMENT REGARDING FEDERALLY SPONSORED RESEARCH

Not applicable.

### BACKGROUND

Rotary clutches are used to provide resistive loading between a rotating component and an adjacent component. The intent is usually to prevent relative rotation between components as is typical of clutches used in automotive drive trains. They can also be used to provide resistive loading of a magnitude small enough to allow relative rotation between components for many applications. The purpose may be to dissipate energy as is the case with brakes, or in some cases, the purpose may be to limit the magnitude of torque that can be applied before relative rotation occurs. This may be done to tune resistance as the end goal as is the case with some exercise equipment or athletic trainers. Torque limiting is also useful as a mechanical fuse to prevent damage to expensive or delicate components such as gear boxes.

Conventional rotary clutches are typically mechanical, magnetic, pneumatic, or hydraulic. Mechanical clutches require support actuators to be activated when controlled electronically and can be quite large. In the case of magnetic clutches, large heavy coils and large constant input of electrical current is needed for the clutch to activate. Hydraulic and pneumatic clutches require reservoirs, conduits, seals, and/or compressors. These solutions are typically used in applications in which size, weight, mass and power consumption are low design priorities. Stationary assembly robots, turnstiles, and conveyer belt systems are just a few examples.

The growing fields of mobile robotics, exoskeletons, and light weight, energy efficient vehicles could benefit greatly from clutch integration. For example, studies have shown that power efficient clutches can provide energy savings of up to 85% in walking robots, but their implementation is currently precluded due to excessive size, weight, and electronic controllability. Some magnetic clutches may be compact enough for these applications, but their weight and high power consumption negates the benefits they offer. Robotics designers have found that it is just as effective and less expensive to utilize existing motors to perform functions that may be better suited to clutches such as holding a stationary joint pose.

An electrostatic clutch can be a lightweight, compact, and power efficient solution. For the same level of performance an electrostatic clutch can weigh significantly less than an electromagnetic clutch and consume 1/1000^{th} the amount of power in the activated state. An electrostatic clutch could provide benefits over existing solutions in one or more of the following areas: improved precision and accuracy of force limitation, compactness, reduced overall weight, increased energy efficiency, improved controllability and responsiveness, reduced complexity and number of components, reduced heat production, and reduced cost. However, several challenges limit the minimum size of rotary clutches and affect their performance.

Previous electrostatic clutch designs involve inner electrodes that interact with a shaft and an outer electrode that interacts with a housing. These electrodes either have features to interact with the shaft or housing or are mounted on structural components that do. These features are most typically splines, gear teeth or key-ways. These elements introduce backlash into the system, take up radial space, and have limited torque transmission capability.

As previously mentioned, markets in which mass and power consumption are design priorities are potential markets for electrostatic clutches. Many products in this space are highly specialized and take advantage of frameless motors and custom gearboxes selected to fit into custom housings. It would be beneficial for an electrostatic rotary clutch to be easily customized in terms of overall length and diameter to most easily be incorporated into these specialized assemblies. Further, it would be advantageous to develop an electrostatic clutch that improves upon the limitations of previous designs and permits implementation in many applications.

### BRIEF SUMMARY

In one embodiment, a rotary clutch comprises multiple electroadhesive clutch units that are laminated together. Each clutch unit is modular and can be joined with any number of additional clutch units to form the clutch. The clutch provided advantages compared to previous electrostatic clutches that employ an outer housing to provide environmental sealing and mechanically connect clutch units to a device input or output. Aspects of the clutch also enable streamlined manufacturing and assembly methods. End caps and adapters can be employed to connect the clutch to a variety of input and output configurations, including keyed shafts, flanged attachments. The clutch can also be used in a frameless configuration.

The magnitude of torque that each pair of clutch electrodes can produce in a rotary clutch is greatly affected by the diameter of the clutch interface, the area over which the clutch electrodes overlap and generate attractive force. The magnitude of torque scales with the radius cubed, so there are performance benefits to increasing the diameter of the clutch interface, especially if this can be done without also increasing the overall diameter of the clutch device. Further, a plurality of clutch electrodes act in parallel to increase the amount of force or torque the clutch can produce. The clutch disclosed herein increases the number of clutch electrodes that fit into each unit length of the rotary clutch, which improves the torque to length ratio.

By using stacked or laminated clutch units, no structural housing is required for transmitting loads from one set of clutch members to the output because the clutch members form a type of integrated housing. The benefits of this clutch include reduced total number of components and rapid customization of clutch length and torque capability by selection of the number of clutch units in the stack. This clutch also lends itself well to applications in which a frameless design may be preferred.

### BRIEF DESCRIPTION OF THE SEVERAL VIEWS OF THE DRAWINGS

FIG. 1 demonstrates the principle of electrostatic adhesion.

FIG. 2 is an assembled view of an individual closed clutch unit.

FIG. 3 is an exploded view of an individual closed clutch unit.

FIG. 4 is an exploded view of an individual closed clutch unit according to an alternative embodiment.

FIG. 5 shows a complete rotary clutch body assembly with multiple clutch units.

FIG. 6 depicts an adapter and inner structural element with a reinforced mechanical interface.

FIG. 7 shows an assembled clutch body comprising multiple clutch units, an inner clutch member adapter, and an electronics enclosure.

FIG. 8 is an exploded view of an assembled clutch body comprising multiple clutch units, an inner clutch adapter, and electronics enclosure.

FIG. 9 is an exploded view of an individual open clutch unit utilizing a planar outer clutch electrode and a spacer.

FIG. 10 shows an individual open clutch unit with an L-shaped cross-section when taken across its diameter.

FIG. 11 is a cross-sectional view of an embodiment of an open clutch unit with an L-shaped cross section.

FIG. 12 depicts two open clutch units assembled featuring outer clutch members with L-shaped cross-sections.

FIG. 13 is a closed clutch element with an outer clutch member structural element that has a T-shaped cross-section.

FIG. 14 shows a closed clutch element with an outer clutch member structural element that has an L-shaped cross-section.

FIG. 15 depicts two closed clutch units with steps in the outer clutch member structural element for self-aligning purposes.

FIG. 16 shows an individual open clutch unit with an outer clutch member with a T-shaped cross section.

FIG. 17 depicts a clutch with shaped outer clutch members for transmission of torque to a matching recess in a greater mechanical structure.

FIG. 18 is an exploded view of a clutched ball bearing.

FIG. 19 depicts an embodiment of a frameless clutch body having multiple clutch units, a slip ring, and an electrical connector.

FIG. 20 shows a frameless clutch body according to an alternative embodiment.

FIG. 21 shows a clutch body comprised of multiple clutch units with face mounting and keyway adapter, according to an alternative embodiment.

FIG. 22 shows a closed clutch unit comprising two separate outer clutch member structural elements, according to an alternative embodiment.

### DETAILED DESCRIPTION

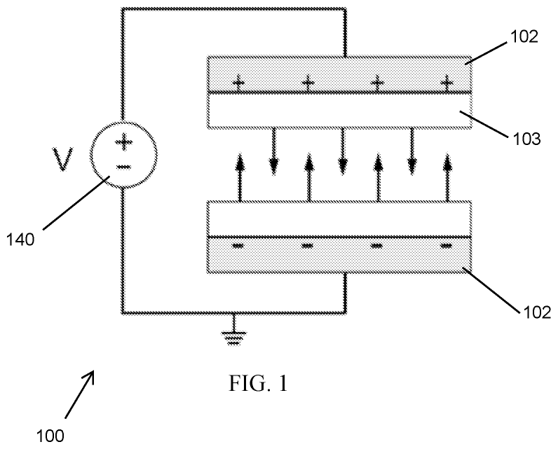

Disclosed herein is a clutch 100 comprising a plurality of clutch units 110, which act together to supply loading to resist relative rotary motion between a mechanical input and an output. FIG. 1 shows a basic structure of an electrostatic clutch. The electrostatic clutch shown in FIG. 1 includes a pair of clutch members comprising a pair electrode 102 and a dielectric material 103 separating opposing electrodes 102. A controller 140 applies a voltage across the electrodes 102. The maximum magnitude of the resistance experienced before slipping can be controlled by altering the voltage applied to the clutch. For the purpose of concise description, “clutch member” may be used to describe a component or group of components capable of acting as an electrode 102 and transmitting a mechanical load resulting from electrostatic attraction. Some embodiments of a clutch member include an electrode 102, an electrode 102 with a carrier, and a rigid substrate coated with a conductive layer. Clutch members may include a dielectric material. Further, “clutch interface” refers to the overlapping area of the input and output electrodes 102 over which a force of adhesion is established in the engaged state and may also refer to the opposing surfaces of the clutch members that contact one another.

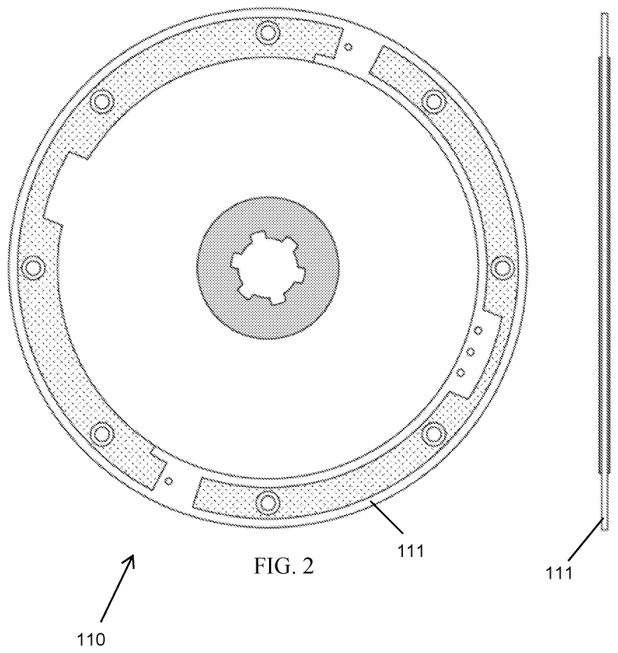

The rotary electroadhesive clutch 100 comprises one or more clutch units 110. FIG. 2 depicts a single clutch unit 110, where the clutch unit 110 comprises at least one clutch member associated with a mechanical input and one clutch member associated with a mechanical output. The clutch units 110 are combined to create a clutch 100 capable of transmitting greater mechanical loads than a single unit 110 would be capable of applying alone. The clutch unit 100 can be combined with any number of additional clutch units 110 to achieve a greater clutch 100 of any size and torque capability.

Referring again to FIG. 2. the clutch unit 110 further comprises a reinforcing structure 11, which may include an outer structure 111, an inner structure 111. A clutch member is disposed on each of these reinforcing structures 111. The outer structure 111 in the embodiment shown in FIG. 2 is a ring with a holes disposed on an outer circumference of the ring. The holes are used to fasten the clutch unit 110 to an additional unit(s) 110 as well as for attachment to greater mechanical structures. The reinforcing structure 111 may also include conductive regions for establishing electrical connections between adjacent units 111. The outer reinforcing structure 111 is connected to two clutch members or electrodes 102. These two outer clutch members enclose an inner clutch member or electrode 102. Stated differently, the inner electrode 102 interacts with a first outer electrode 102 on one surface and interacts with a second outer electrode 102 on its opposing surface. In this embodiment, the inner clutch member includes a toothed profile as a mechanical interface for a splined shaft. A side view in FIG. 2 shows the thinness of the clutch unit 110.

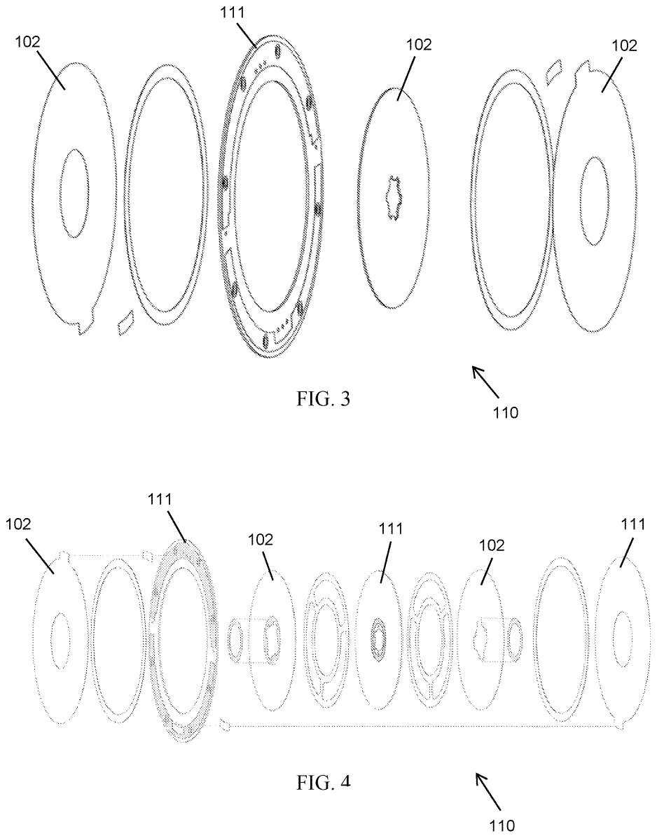

FIG. 3 shows an exploded view of the clutch unit 110 depicted in FIG. 2. The reinforcing structure 111 is similar to a printed circuit board in construction. For example, the reinforcing structure 111 can be constructed from FR4 fiberglass with conductive pads disposed on the surfaces. Vias establish electrical connection from conductive regions on the top of the reinforcing structure 111 to conductive regions on the bottom of the reinforcing structure 111. The outer and inner edges of the reinforcing structure 111 are fiberglass and are therefore insulated from the conductive pads. Clutch electrodes 102 are adhered to the reinforcing structure 111 using a ring of pressure sensitive adhesive or similar connection mechanisms. An electrical connection is established to the outer clutch electrodes 102 using conductive adhesive.

In this embodiment, the outer clutch electrodes 102 are electrically isolated from each other such that a voltage potential can be applied across them. The inner clutch member is a single component in this embodiment acting as both a reinforcing structure 111 capable of transmitting mechanical loads and as an electrode 102. A dielectric material 103 separates the inner and outer clutch electrodes 102 and may be disposed on the outer, inner, or both sets of clutch electrodes 102. In this embodiment the inner clutch member is electrically isolated such its only electrical connection to the clutch circuit or controller 140 is through the clutch interface between the surfaces of the inner and outer electrodes 102. In this configuration, the clutch unit 110 acts as two capacitors in series with the interface between each pair of outer and inner clutch electrodes 102 acting as a capacitor. The inner clutch electrode 102 experiences a voltage potential that is intermediate between the potentials experienced by the outer electrodes 102.

In the embodiment shown in FIG. 2, there is one inner clutch electrode 102 and two outer electrodes 102, where the outer clutch electrodes 102 are flexible. These flexible electrodes 102 may comprise a single continuous material such as a thin sheet of stainless steel. Or the outer electrode 102 may comprise several materials such as a polymer carrier, a thin coating of conductive material, and a dielectric coating 103 disposed on the surface of the conducting material. In this embodiment, each unit 110 comprises two outer electrodes 102 for the outer clutch member. This type of clutch unit 110 in which two outer electrodes 102 enclose one or multiple inner electrodes 102 will be referred to as “closed” clutch unit 110. Each closed clutch unit 110 can act as a clutch individually or in combination with additional clutch units 110.

As previously noted, each pair of electrodes 102 must include a dielectric material 103 disposed between the electrodes 102 and at least one of the electrodes 102 is flexible or semiflexible. These general design characteristics can be accomplished in many configurations. Flexible electrodes 102 are disposed on reinforcing structures 111 that may be machined metal, sheet metal, fiberglass, or other material. The mechanical attachment between the flexible electrode 102 and the reinforcing structure 111 may be achieved by pressure sensitive adhesive, adhesives, heat lamination, clamping either between clutch units 110 or between other components, laser sintering, welding, stitching, or other attachment methods. The attachment method may be applied to the entire area of the flexible electrode 102 overlapping with the reinforcing structure 111 or only a portion.

FIG. 4 shows an embodiment of the clutch 100 comprising two electrodes 102 forming the inner clutch member and two electrodes 102 forming the outer clutch member. In this embodiment, the outer clutch members comprise flexible electrodes 102. These flexible electrodes 102 may comprise a single continuous material such as a thin sheet of stainless steel. Or it may comprise several materials such as a polymer carrier, a thin coating of conductive material, and a dielectric coating 103 disposed on the surface of the conducting material. In the embodiment shown in FIG. 4, an electrical connection is established between the outer electrode 102 and the outer reinforcing structure 111 using conductive adhesive. The inner clutch member is composed of a reinforcing structure 111 with toothed elements for interfacing with a greater mechanical structure. The inner flexible electrodes 102 are adhered to the inner structure 111 using selectively patterned pressure sensitive adhesive. An electrical connection is established between the electrodes 102 and a conductive region on the surface of the inner structure 111 using a conductive ring with conductive adhesive applied. This ring touches both the electrode 102 and the conductive region of the inner structure 111.

The conductive regions on the top and bottom of the reinforcing structure 111 are electrically connected by vias. Alternatively, this electrical connection between inner electrodes 102 may be achieved simply by adhering, mechanically clamping, some structural element being conductive in bulk or by the use of pass throughs or cut outs, or by the use of a single electrode 102 that is folded. For example, the inner electrodes 102 may be one continuous piece of material that is folded around the inner structural member 111.

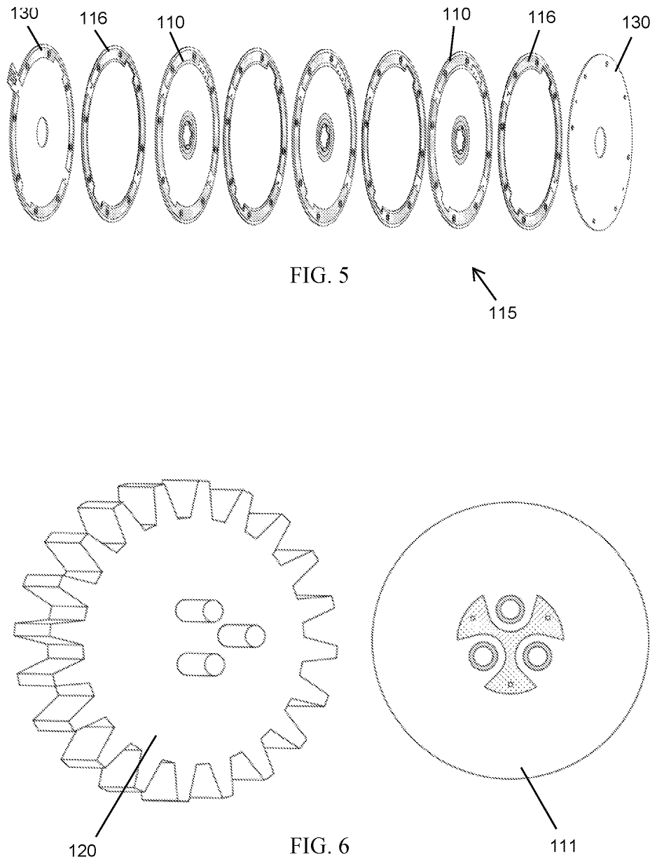

FIG. 5 shows an embodiment of a greater clutch structure called a clutch body 115 comprising many clutch units 110. The clutch units 110 shown in this embodiment are the units 110 shown in FIG. 4. In this embodiment, clutch units 110 are stacked together to create a rotary clutch capable of transmitting much more torque than a single clutch unit 110 alone. Three clutch units 110 are shown in FIG. 5, but any number of clutch units 110 may be used. Further, the clutch units 110 are separated by spacers 116 to prevent interference between the outer electrodes 102 of adjacent units. Electrical connections are established at the tab of the left-most element, or top cap. This element acts as a top to protect the flexible electrodes 102 of the clutch unit 110 b and as the electrical connection to the greater structure in which the clutch body 115 operates. Similarly, the right-most element, or bottom cap, protects the bottom clutch unit 110 from damage, but does not include electrical connections.

The top cap, spacers 116, and clutch units 110 all include patterned conductive regions that align. As a result, mechanical contact between the top cap and the top spacer 116 transmits voltage between them. Vias in the spacer 116 transmit voltage to the bottom of the spacer 116 and mechanical contact transmits voltage to the next clutch unit 110. This pattern repeats such that all the clutch units 110 are electrically connected. In this embodiment, there is no need to establish an electrical connection to the inner clutch members. The clutch units 110 are non-conductive at their outer perimeter such that the assembled clutch body 115 is insulated by the reinforcing structures 111 of the clutch units 110 themselves and the top and bottom end caps.

The mechanical attachment between clutch units 110 is achieved by holes in the clutch members through which a rivet, bolt, stake, or other attachment mechanism is inserted to mechanically secure the clutch units 110. The design of the clutch 100 is in contrast to previous designs in which clutch member outer structural elements individually fit into and transmitted torque to a housing or adapter component. The housing member was often a monolithic structure of a fixed length. Further, when activated to the engage state, each clutch member moved relative to its resting position in the housing, compressing the entire stack of clutch members. In contrast, the clutch member outer reinforcing structures 111 or rigid outer electrodes 102 form a composite structure capable of transmitting torque through mechanical connections between clutch units 110 and the clutch units 110 maintain their relative position.

Individual clutch units 110 may be mechanically connected through a variety of means. Clutch units 110 may be stacked together and connected via welding or laser sintering with torque transmitted between units 110 through the welded portions. In other embodiments, the clutch units 110 may be mechanically connected via adhesives such as bonding varnishes, epoxies, or polymers. In other embodiments, the clutch units 110 may be connected by additional attachment hardware. Rivets, stakes, or bolted connections may be used to connect clutch units 110 and transmit torque. This connective hardware may carry the torque through shear loading in the body 115 of the fastener or may clamp the clutch units 110 together such that the majority of the toque loading is transmitted through friction at the interacting surfaces of adjacent clutch units 110. In embodiments involving connective hardware, a bolt circle or other cut out portions may be made in each clutch unit 110. In some embodiments, much or all of the torque is transmitted to an external mechanical structure through friction between the clutch member outer reinforcing structure 111 or rigid outer electrodes 102. The inner clutch members connect to a splined shaft using toothed connections.

As previously discussed, the clutch body 115 is the composite structure formed by multiple clutch units 110, acting as complete clutch 100. The clutch body 115 may comprise a single independent clutch unit 110, a stack of repeating clutch units 110, or a stack of repeating clutch units 110 with additional components. A clutch body 115 may further comprise a mechanical input, a mechanical output, and a method of establishing an electrical connection to a greater electromechanical system.

FIG. 6 shows an alternate inner reinforcing structure 111 which mechanically interfaces with pins, where the pins could be disposed on an external structure or input/output element. In this embodiment, the cutouts are reinforced with a material that is different from base material of the reinforcing structure 111. This may be achieved through a plating process. In other embodiments, a separate component such as a tube or shaped insert may be inserted into the reinforcing structure 111 and retained by press fit, glue, epoxy or other means. This interface may be applied to any shape connector be it splined, pinned, hex shaped, star shaped, or other arbitrary shape.

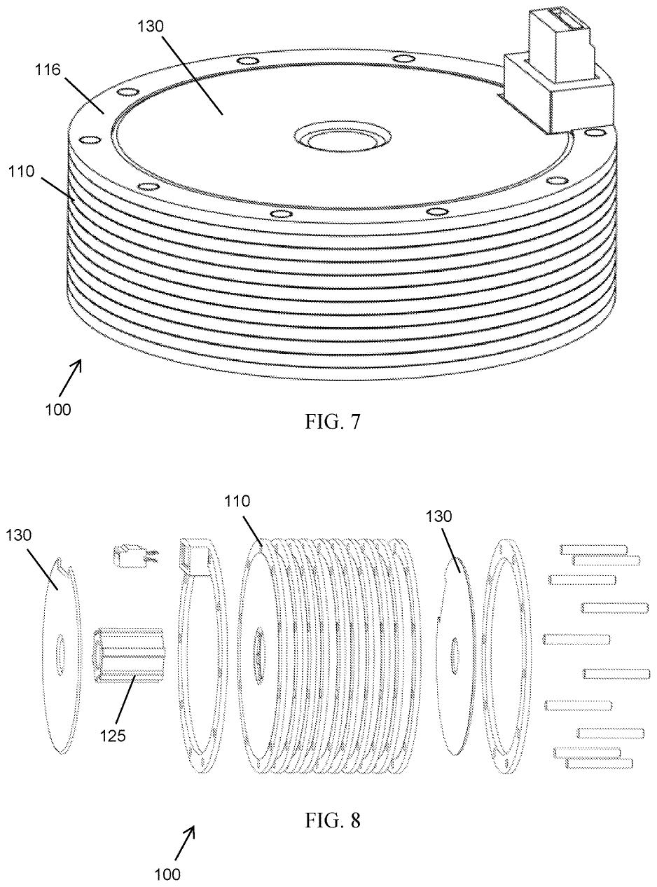

FIG. 7 shows yet another alternative embodiment of a clutch 100 in which ten clutch units 110 are stacked together with an end ring and end cap. The end caps act to retain an inner clutch member adapter 125 and to protect the flexible electrode from damage. The end rings include an electronics enclosure where electrical connectors can be attached.

By way of further example, FIG. 8 shows an exploded view of the embodiment shown in FIG. 7. The clutch 100 in this embodiment includes an adapter 125. This adapter 125 acts as a spline shaft and can be press fit onto a round shaft included in a greater mechanical structure 120 in which the clutch is operating. The stack of clutch units 110 and the end rings are fastened to one another using stakes, rivets, bolts, or other fasteners. Adapters 125 may include set screws, split hub clamps, press fits, keyways or other fasters or shapes to enable the clutch 100 to attach to a mechanical input 120. This clutch body 115 embodiment is “frameless” meaning it does not include holes for bolted attachment to a greater mechanical structure 120.

In the embodiment depicted in FIG. 8, the electrical connector shown is a zero insert force connector (ZIF) designed to interact with a flex or ribbon cable. The type of cable and connector is not significant other than to be compact and appropriately sized for electrical current.

The inner clutch member connectors mechanically connect to an adapter. A clutch cap provides a seal to protect the clutch 100 from ingress of foreign materials. An end ring and a secondary cap are used to protect the flexible electrode 102 of the terminal clutch unit 110. In this example embodiment, the stack of clutch units 110 is held together via rivets. Other embodiments may achieve a bond between clutch units 110 via epoxy-based bonding agents, polymer-based bonding agents, rubber-based bonding agents, varnishes, laser welding, spot welding, line welding, bolted connections, sintering, or other means of attachment.

The adapter 125 shown in FIG. 8 has a round inner cutout for press fitting onto a shaft. This cut out may be keyed, splined, or otherwise shaped to interact with the clutch's mechanical input, or surrounding mechanical system 120. Embodiments are possible in which there is no inner clutch member adapter 125. In some embodiments, the mechanical input 120 to the clutch 100 interacts directly with the inner clutch members of each clutch unit 110. In other embodiments, the inner clutch members are laminated using one of the previously mentioned bonding methods. The clutch 100, containing one or more clutch units 110, may include components 130 that are disposed at one or both ends of the clutch unit stack. These end components 130 may be used for a variety of purposes including but not limited to: housing of electronics or a controller 140, housing of sensors, and electrical isolation of the clutch unit 110. These end components 130 may include flanges, through holes, threaded holes, split hub clamps, other clamping features, or other or other features for connecting to the input or output of the clutch 100. These end components 130 may be comprised of one, multiple, or no electrode pairs.

In order for electrostatic adhesion to occur between opposing electrodes 102, they must experience a difference in electrical potential. As such, the inner and outer electrodes 102 must remain electrically isolated from each other across a dielectric material 103 when in the engaged state. A controller 140 using relays, transistors, MOSFETS, or other circuitry can be used to short the inner and outer electrodes 102 together to equalize their electrical potential and cease the electroadhesive effect. In some embodiments, the outer clutch member electrodes 102 attach in series with one another to a terminal of the power supply or controller 140. In other embodiments, the outer clutch member electrodes 102 are each electrically connected in parallel to a terminal of the power supply or controller 140. In some embodiments, the inner clutch member electrodes 102 can all have a positive voltage applied and the outer clutch member electrodes 102 can all have a negative voltage applied to activate adhesion and torque transmission. In some embodiments, each clutch member can be separately activated with a positive voltage on one clutch member electrode 102 and a negative voltage on the other clutch member electrode 102.

Multiple electrical configurations are possible to control the clutch units 110 between engaged and disengaged states. In some embodiments, the inner clutch members receive electrical power through a slip ring connection. In some embodiments, the inner clutch member electrodes 102 are electrically connected in series with one another to the rotating slip ring contact. In other embodiments the inner clutch member electrodes 102 are each electrically connected in parallel to the rotating slip ring contact. In instances in which inner clutch members are connected in series, electrical connections between them may be maintained via spring finger connections, conductive washers, pogo-pins, permanent wired connections, soldered rods, vias, flex cabling, or other electrical connection. In cases in which the inner clutch electrodes 102 are connected in parallel, the electrical connection may be made through the adapter 125 or splined shaft through mechanical contact alone. In other embodiments, the inner clutch members may receive voltage in a parallel configuration through a slip ring or another method.

In other embodiments, no explicit electrical connection to the moving clutch members is needed. This is enabled by connecting two or more inner clutch members such that they are electrically connected. A voltage potential is then applied across two or more non-moving clutch members such that moving clutch member electrodes 102 are located between them and connected only across the dielectric material 103 separating the electrodes 102. The moving clutch electrodes 102 exist at a voltage between the voltages applied to the top and bottom stationary electrodes 102.

The clutch 100 containing one or multiple clutch units 110 may connect to a greater mechanical device 120 through several means: via clamping either across the flat faces of the clutch 100 or around the circumference of the clutch body 115, bolted connections on flange(s) or face(s), press fit, keyed connection, shaft mounting or other attachment method. The clutch units 110 may be disposed within a housing, insulating envelope, or sleeve 126. This envelope may be electrically insulating, structural, or aesthetic. The stacked rotary clutch 100 can be configured to be face mounted, flange mounted, shaft mounted, clamped, keyed or otherwise shaped to connect to the mechanical input/output of a greater mechanical system 120.

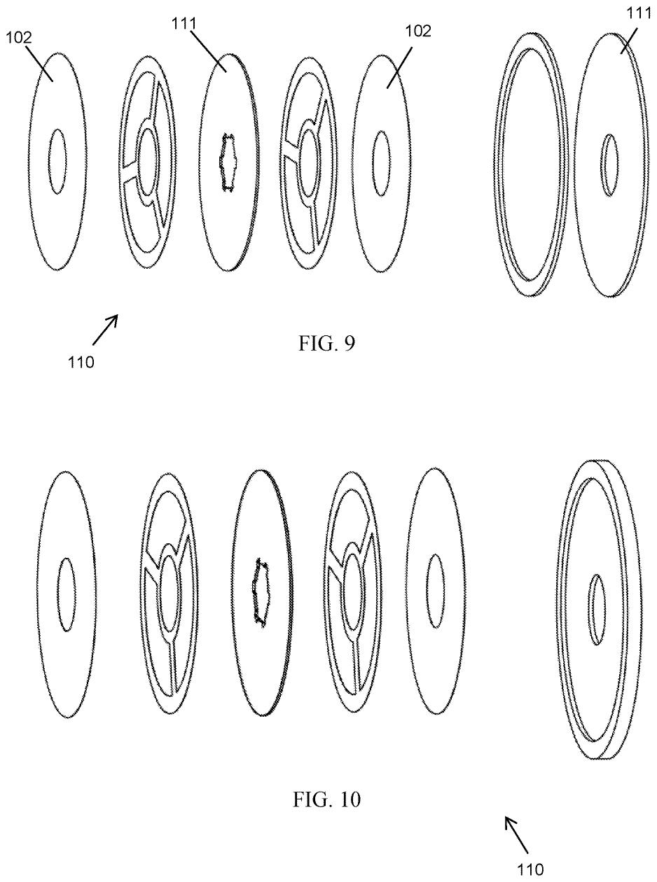

FIG. 9 depicts another embodiment of a clutch unit 110 inch which the outer clutch member comprises a planar outer clutch member acting as a reinforcing structure 111 and a ring-shaped spacer. In this embodiment only one outer electrode 102 is included in the repeating clutch unit 110. In this embodiment shown in FIG. 9, the inner clutch member includes two flexible electrodes 102 and the outer clutch member may be flexible or rigid. The first of the inner clutch electrodes 102 pairs with the included outer clutch member. The other inner clutch electrode 102 pairs with the outer electrode 102 of an adjacent clutch unit 110, when multiple units 110 are stacked. The outer clutch member electrode 102 may be electrically conductive on both planar surfaces of the electrode 102, with or without an insulating carrier sandwiched between the planar surfaces. This is an example of an “open” clutch unit. Here, an “open” clutch unit 110 is a clutch unit 110 that is adapted to be stacked with additional units 110 in a repeating order such that a clutch interface exists between the adjacent units 110.

FIG. 10 depicts an embodiment of an open clutch unit 110 with an outer clutch member comprising a reinforcing structure 111 with an L-shaped cross section. In this configuration, the mechanical connection between clutch units is established through the outer reinforcing structure 111. The outer structure 111 may be comprised of multiple separate parts that are assembled together before the lamination stack of clutch units 110 is assembled or while the lamination stack is assembled. These parts could be held together with glue or other adhesion methods, by press-fits, bolts, rivets, or other mechanical connection methods, or by surface friction resulting from the normal force of the full stack lamination.

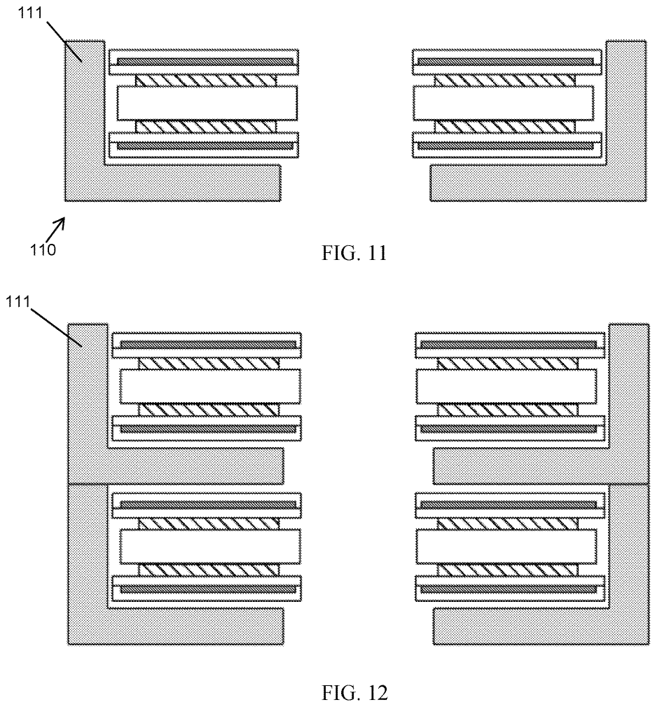

FIG. 11 shows a cross sectional view of the embodiment depicted in FIG. 10, where the reinforcing structure 111 has an L-shape and is assembled in an open clutch unit 110. In this embodiment, the inner clutch members are flexible and comprised of a polymer carrier with an electrode 102 disposed on one surface. A dielectric 103 is then disposed on the electrode 102. The composite clutch member is then adhered to the inner clutch structure 111 suing pressure sensitive adhesive. One of the inner clutch members interfaces with the outer clutch member. The outer clutch member in this example embodiment is rigid. The other inner clutch member must interface with another clutch unit 110 or a singular clutch member disposed on an end cap.

FIG. 12 shows two of clutch units 110 shown in FIG. 11 assembled together. As shown in FIG. 12, one of the inner electrodes 102 of the bottom clutch unit 110 forms a clutch interface with the outer electrode of the top clutch unit 110. The thickness of the parts is controlled to maintain a small gap that can be overcome by movement of the flexible electrode 102 when voltage is applied. In other embodiments, the thickness of the parts is controlled such that the clutch members are in contact even when voltage is not applied.

The outer clutch member in FIGS. 9-12 may comprise a single component produced in the desired shape, or may comprise a permanent assembly of multiple components that may be assembled before or during lamination with or without alignment tools, or may consist of multiple components that are compressed together during or after lamination. For example, the outer clutch of FIG. 9 could constructed as a single component, or could be constructed as two planar components stacked on top of one another.

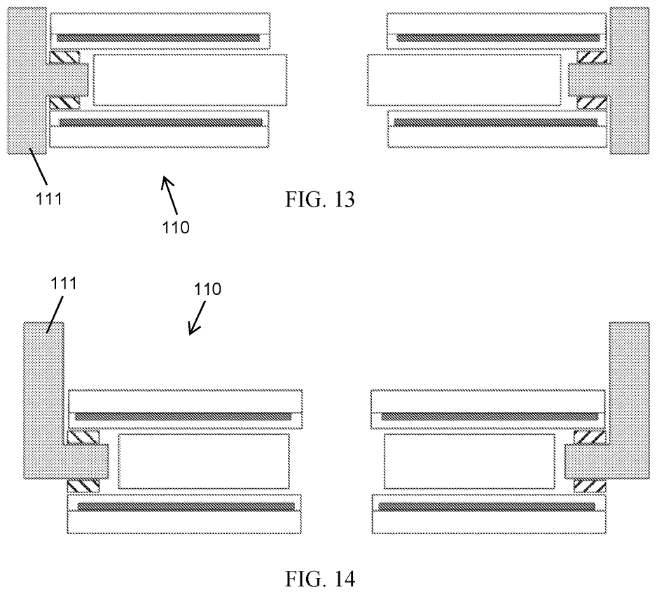

FIG. 13 depicts an alternative embodiment of a closed clutch unit 110 in which the outer clutch member comprises a reinforcing structure 111 with T-shaped cross section and two electrodes 102 surrounding an inner clutch member. In this configuration, the mechanical connection between clutch units 110 is established through the outer portion of the structure 111 of the outer clutch member. The electrodes 102 in this embodiment are flexible and adhered to the outer reinforcing structure 111 using pressure sensitive adhesive.

FIG. 14 depicts a closed clutch unit 110 with an outer clutch member structure 111 that has an L-shaped cross-section, with the inner clutch member occupying a space in the middle and surrounded by two outer electrodes 102.

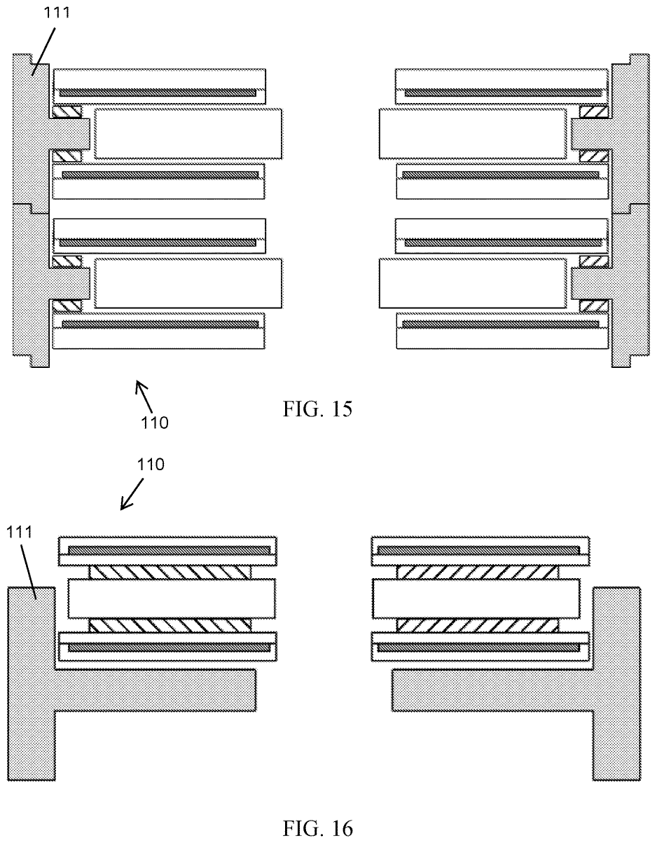

FIG. 15 depicts clutch units 110 with reinforcing structures 111 that are self-aligning. In this configuration, the outer reinforcing structure 111 comprises a recess on one side in which another identical unit can rest. In some embodiments, the self-aligning feature may be a recess with shape capable of transmitting torsional loads between clutch units 110. Shapes may include but are not limited to splined shaped, keyed shapes, hex shapes, wave shapes, other polygonal shapes, star shapes, or abstract shapes. In some embodiments, the self-aligning feature may involve matching recessed and extruded features with shape capable of transmitting torsional loads between clutch units 110. Shapes may include but are not limited to splined shapes, keyed shapes, hex shapes, other polygonal shapes, star shapes, or abstract shapes. These self-aligning configurations can also be achieved with an open clutch unit 110. In this embodiment, the outer clutch member electrodes 102 each adhere to one surface of the inner clutch member. Other methods of alignment between clutch units 110 may include holes with aligning pins or dowels, matching positive and negative features, or mechanical confinement in a tube or other outer shape that may remain present after assembly, or be removed.

FIG. 16 depicts an embodiment of an open clutch unit 110 with an outer clutch member with a T-shaped reinforcing structure 111. The inner clutch members may comprise a keyed or splined hole or recess for connection to a shaft or other mechanical input or output, which is not depicted in the figures for the sake of clarity in the cross-sectional view.

An intermediate component may be used to interface with inner reinforcing structures 111 and the mechanical input or output of the surrounding mechanical system 120. This component will be referred to as an adapter 125. For example, FIG. 8 shows an exploded clutch assembly in which a splined adapter 125 interacts with inner clutch member splines. The adapter 125 may also include a hole for press fitting onto a shaft. This hole may include a key to interact with a keyed shaft in other embodiments. In other embodiments, this adapter 125 may comprise a shaped hole for interfacing with a similarly shaped input such as a D-shaft or hex shaft. The inner clutch members may also be mechanically attached to the adapter 125 by epoxy, welding, retaining rings, or other attachment hardware. The adapter 125 may comprise an electrically insulating element to electrically isolate the inner clutch electrodes 102 from the input shaft.

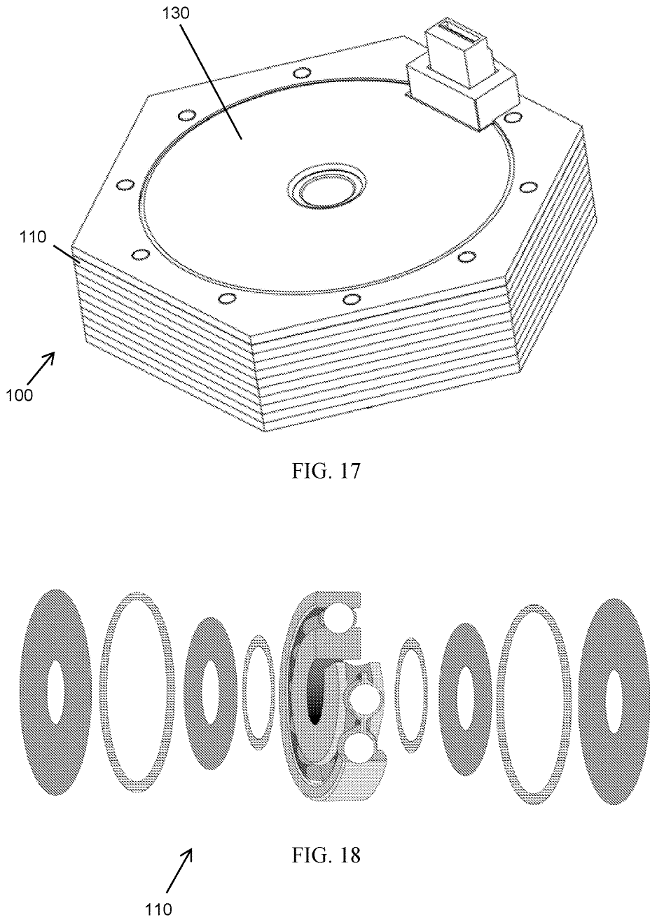

FIG. 17 shows an embodiment of a rotary clutch 100 in which the shape of the clutch body 115 is configured to be constrained by a matching negative shape in the greater mechanical system 120. This eliminates the need for an intermediate housing component that has an internal shape that fits the outer clutch body 115 shape, and an external attachment feature that connects with a greater mechanical structure 120. The shape may be square, rectangular, hexagonal, star shaped, D shaped, keyed, generically polygonal, oval, or abstract. Similarly, the outer perimeter of the clutch units 110 may be shaped to interact with an adapter or housing to enable transmission of mechanical loads to a greater mechanical structure 120. The adapter may be electrically isolating.

FIG. 18 shows an embodiment in which the clutch unit 110 comprises rollers, a roller cage, and inner and outer rolling surfaces. The rollers, roller cage, and inner and outer roller surfaces are well known in prior art as a ball bearing. This clutch-enhanced ball bearing is capable of rotating freely in the off state, or resisting rotation, or even locking in the on state. This clutch unit 110 comprises a clutch member mechanically attached to the inner race of the bearing and a clutch member mechanically attached to the outer race of the ball bearing. The clutch member shown extends past the outer diameter of the inner race and overlaps a portion of the gap between the races. In other embodiments, the inner clutch member may not extend past the inner race outer diameter, or the inner clutch member may comprise the inner race itself. The outer clutch members extend from the surface of the outer race and overlap substantially with the inner race clutch member. Electrical connections may be established through the shaft and bearing cup directly. Electrical cables, clamps tails or other connectors may be added to the stationary clutch members to establish electrical connection. The rotating clutch members may maintain electrical connection through the interface with the shaft or housing or via a slip ring or other sliding electrical connection. This type of clutch unit 110 may be used in isolation, in pluralities, or in tandem with clutch units 110 without roller elements. Other embodiments in which rolling elements are disposed between the inner clutch member and the outer clutch member may not involve a ball cage. Cylindrical rollers may be used in place of balls. This type of clutch unit 110 may be used in isolation, in pluralities, or in tandem with clutch units without roller elements.

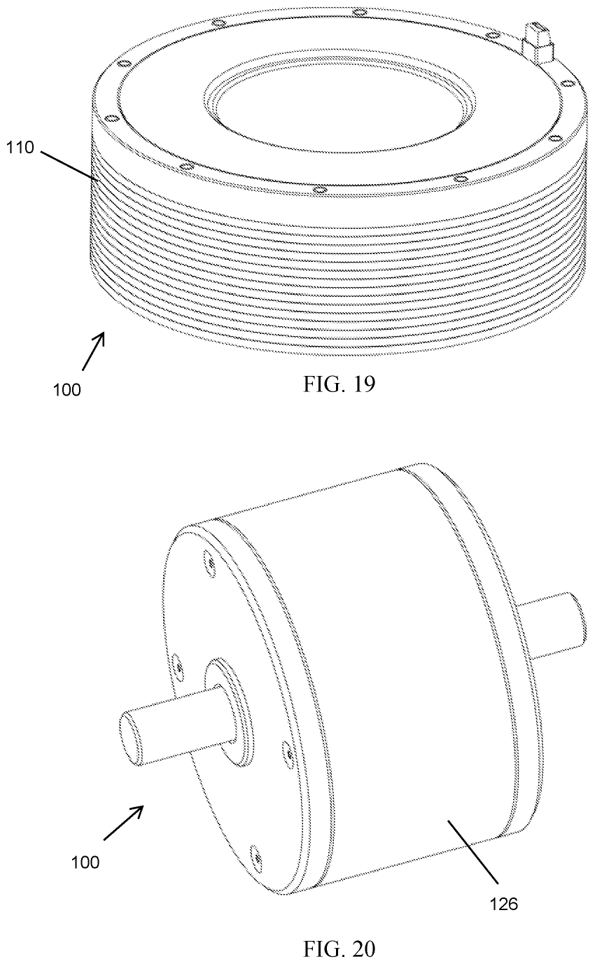

FIG. 19 depicts a frameless clutch body 115. This embodiment does not include bolt holes or other features to interact with fasteners like screws, but is instead intended to be press fit or clamped into a housing integrated into a greater structure 120.

FIG. 20 depicts an embodiment in which the clutch body 115 is shaft mounted. The input and output are each attached to a shaft. One shaft is connected to an end cap 130, and therefore the outer clutch members. The other shaft is mechanically attached to the inner clutch reinforcing structure 111. In other embodiments, a housing may act as the input and attach via face or flange mounting while the output is a shaft that extends through the body of the clutch 100 and interacts directly with the inner clutch members. A bearing or multiple bearings may be seated in end caps 130 or in other plate-like components at an intermediate location in the assembly.

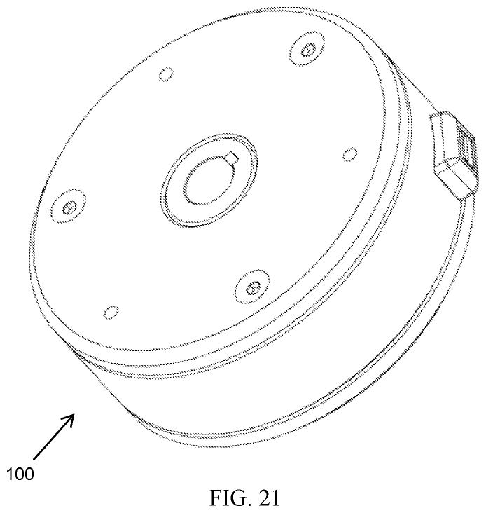

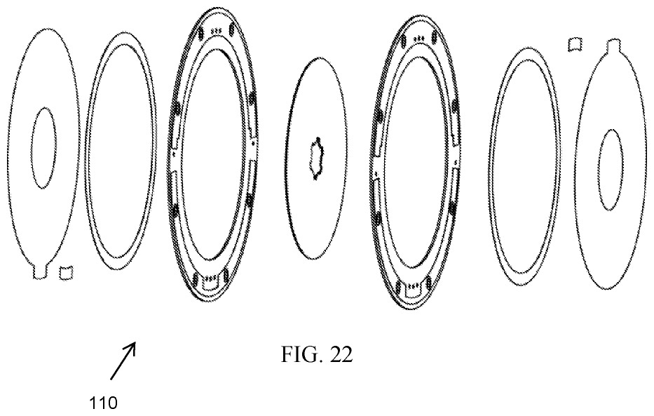

FIG. 21 shows an embodiment of a clutch 100 comprised of multiple clutch units 110. The clutch's mechanical input is a pattern of threaded holes for face mounting. The output is an adapter 125 that is mechanically connected to the inner clutch members. This adapter 125 comprises a keyway for attaching to a keyed shaft. An over-molded electrical connector is attached to an end cap 130 and a thin sleeve 126 covers the clutch stack for environmental sealing. This sleeve 126 does not need to transmit mechanical loads and is therefore thinner than the housings of prior electrostatic clutches. Sleeves 126 for electrical insulation or environmental protection may be rigid such as metal, plastic or composite sleeves 126 or may be flexible such as a sleeve 126 formed by heat shrink tubing. The sleeve 126 may also be a conformal coating applied as a liquid and cured.

FIG. 22 shows an embodiment of a closed clutch unit 110 which can be disassembled. The clutch unit 110 comprises two outer clutch members each disposed on their own outer reinforcing structure 111. The outer clutch members make electrical connection to their reinforcing structures 111 through conductive adhesive. The reinforcing structure 111 establish electrical connections between themselves and other repeating clutch units 110 through mechanical contact of their conductive surface regions. These two outer clutch members enclose an inner clutch member. Bolt holes allow the clutch unit 110 to be secured together as an individual clutch unit 110 or as a greater clutch body 115.

Each of the embodiments shown may be used in isolation or as a plurality. Each clutch must include at least two electrodes 102, but may include any number of electrodes 102.

In some embodiments the clutch 100 may be activated in response to sensor data from accelerometers, pressure sensitive switches, IMUs accelerometers, biological sensors such as EMG sensors, optical sensors, encoders or others. For example, in some embodiments of the rotary clutch 100, a sensor may be included internal or external to the clutch 100 to measure rotation of the clutch 100 and/or its associated joint in a greater device or mechanical system 120. This sensor may be an optical sensor, magnetic sensor, an electrical brush or spring finger contact interacting with a patterned conductive surface, or an inductive sensor. Signals from this sensor may be used to inform or control clutch behavior. For example, greater voltage may be commanded nearer to the boundaries of the greater device's range of motion and less voltage may be applied near the center of its travel. The clutch 100 may also include a sensor for measuring the torque applied and/or transmitted, such as a strain gauge, multiple strain gauges, or fluid pressure based sensors. The clutch 100 may also include temperature, humidity, air pressure, chemical, or other sensors to inform the clutch controller 140.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. In particular, one or more features in any of the embodiments described herein may be combined with one or more features from any other embodiments described herein.

Protection may also be sought for any features disclosed in any one or more published documents referred to and/or incorporated by reference in combination with the present disclosure.

What is claimed is:

1. An electroadhesive clutch comprising:
a plurality of clutch units, wherein each clutch unit comprises:
a reinforcing structure,
a first electrode,
a second electrode, and
a dielectric material disposed between the first electrode and the second electrode,
wherein at least one of the first electrode and the second electrode is flexible.

2. The electroadhesive clutch of claim 1, wherein each clutch unit of the plurality of clutch units is a rotary clutch.

3. The electroadhesive clutch of claim 1, wherein each clutch unit of the plurality of clutch units is modular.

4. The electroadhesive clutch of claim 1, wherein outside clutch units of the plurality of clutch units are physically and electrically connected.

5. The electroadhesive clutch of claim 1, wherein adjacent clutch units of the plurality of clutch units are physically and electrically connected.

6. The electroadhesive clutch of claim 1, wherein at least one clutch unit of the plurality of clutch units further comprises:
a third electrode placed adjacent to the second electrode on a side opposite of the first electrode, wherein the first electrode and the third electrode surround the second electrode forming a closed clutch unit.

7. The electroadhesive clutch of claim 1, wherein at least one clutch unit of the plurality of clutch units has a second electrodes open on one side, forming an open clutch unit.

8. The electroadhesive clutch of claim 1, wherein the clutch is frameless and attaches to a surrounding mechanical system using an attachment mechanism.

9. The electroadhesive clutch of claim 8, wherein the attachment mechanism comprises a bolt, rivet, or fastener.

10. The electroadhesive clutch of claim 1, further comprising an adapter.

11. The electroadhesive clutch of claim 10, wherein the adaptor is electrically insulating.

12. The electroadhesive clutch of claim 10, wherein an outer clutch member of each clutch unit of the plurality of clutch units is electrically isolated from a mechanical input.

13. The electroadhesive clutch of claim 10, wherein an inner clutch member of each clutch unit of the plurality of clutch units is electrically isolated from a mechanical input.

14. The electroadhesive clutch of claim 1, wherein at least one clutch unit of the plurality of clutch units has a different configuration than another clutch unit in the plurality of clutch units.

15. The electroadhesive clutch of claim 1, wherein at least one clutch unit of the plurality of clutch units further comprises an integrated ball bearing.

16. The electroadhesive clutch of claim 1, wherein the plurality of clutch units are connected without an external housing.

17. The electroadhesive clutch of claim 1, wherein the plurality of clutch units are connected to form an integrated housing.

18. The electrostatic clutch of claim 1, wherein the plurality of clutch units are directly electrically connected.

19. The electroadhesive clutch of claim 1 wherein the reinforcing structure is conductive.

20. The electroadhesive clutch of claim 1, wherein the reinforcing structure is partially conductive and partially non-conductive.

21. The electroadhesive clutch of claim 20, further comprising electrical connections through the reinforcing structure using vias.

22. The electroadhesive clutch of claim 18, wherein at least one of the first electrode and the second electrode are connected as one continuous electrode.

23. The clutch of claim 1, further comprising a sleeve encompassing an outer portion of the reinforcing structure.
